(19) United States
(12) Patent Application Publication
(10) Pub. No.: US 2025/0124912 A1
(43) Pub. Date: Apr. 17, 2025

(54) SYSTEM FOR REMOVING A NOISE IN AN ACTIVE WAY

(71) Applicant: Dae Hyun BAEK, Gwangju-si (KR)

(72) Inventor: Dae Hyun BAEK, Gwangju-si (KR)

(21) Appl. No.: 18/487,739

(22) Filed: Oct. 16, 2023

(51) Int. Cl. G10K 11/178

(52) U.S. Cl. CPC G10K 11/17854; G10K 11/17857

(57) ABSTRACT

Provided is an active type of a system for removing a noise. A system for removing a noise in an active way comprises a noise generating source detecting module 11 for detecting a noise generating source generating a noise; a target location detecting module 12 for detecting a location of a target positioned at an area where the noise is transmitted; an active removing sound generating module 13 for generating an active removing sound capable of removing an effect of the noise transmitted to the target; and an active sound transmitting module 14 for transmitting the generated active sound to the target.

### BACKGROUND OF THE INVENTION

### 1. Field of the Invention

The present invention relates to an active type of a system for removing a noise, in particular the system for detecting a characteristic of a noise generated from various sources and transmitting an active noise generated for removing the detected noise to a person to whom the detected noise is transmitted.

### 2. Description of the Related Art

A noise causing a discomfort to a listener may be different according to a psychological state of the listener, and for example, an audible frequency sound generated from a transportation such as a vehicle, a train or an airplane may become a noise. And also, a mechanical sound or a sound by a vibration generated from a construction site or a factory may become a noise, and the noise may have a discordant sound in general. Such sound may become a cause of stress, reduce an activity ability, and generate various mental or physical diseases. Therefore, it is necessary for a noise generating effect to be removed by preventing the noise from reaching to a person who is to be affected by the noise, or by transmitting an active sound capable of removing a noise effect. The noise removal may be accomplished in a structural way, in a way to block a noise generation in advance, or in a way to prevent the noise from reaching the person previously, and various skills related to the noise removal are known in this art. It may be advantage for removing the noise that a suitable way for removing the noise is selected by detecting the generation cause of the noise and the noise is removed actively by generating a sound capable of removing the noise effect.

The present invention is to solve the problems of the prior art and has the following object.

### PURPOSE OF THE INVENTION

An object of the present invention is to provide with a system for removing in an active way by detecting a noise generating source to affect people living indoors and outdoors, detecting a location of the people to whom the noise is transmitted and transmitting a sound to have a noise eliminating effect to the people for removing the noise effect.

### SUMMARY OF THE INVENTION

In one embodiment of the present invention, a system for removing a noise in an active way comprises a noise generating source detecting module for detecting a noise generating source generating a noise; a target location detecting module for detecting a location of a target positioned at an area where the noise is transmitted; an active removing sound generating module for generating an active removing sound capable of removing an effect of the noise transmitted to the target; and an active sound transmitting module for transmitting the generated active sound to the target.

In other embodiment of the present invention, the noise generating source detecting module comprises at least three noise detecting sensors placed at different positions each other.

In another embodiment of the present invention, the target location detecting module comprises at least two location detecting sensors.

In still another embodiment of the present invention, the noise generating source detecting module is placed at a ceiling or a window.

In still another embodiment of the present invention, the target location detecting module comprises an ultrasound sensor or an optical sensor, and is configured to have a function for tracing the location of the target.

In still another embodiment of the present invention, the system further comprises a noise property analyzing module for analyzing a noise form, a noise direction, a periodic property or a generating characteristic.

In still another embodiment of the present invention, the active removing sound is a white noise.

### BRIEF DESCRIPTION OF THE DRAWINGS

FIG. 1 shows an embodiment of a system for removing in an active way according to the present invention.

FIG. 2 show an embodiment of a structure for detecting a noise generating source and a target according to the present invention.

FIG. 3 shows an embodiment of a process for removing a noise transmitted through a window from the outside according to the present invention.

FIG. 4 shows an embodiment a structure for removing a noise generated at an outside of a building according to the present invention.

FIG. 5 shows an embodiment of a structure for removing a noise generated at a road or a street according to the present invention.

FIG. 6 show an embodiment of a structure for removing a noise generated between floors according to the present invention.

### DETAILED DESCRIPTION OF EXEMPLARY EMBODIMENTS

Exemplary embodiments of the present invention will be described herein below with reference to the accompanying drawings.

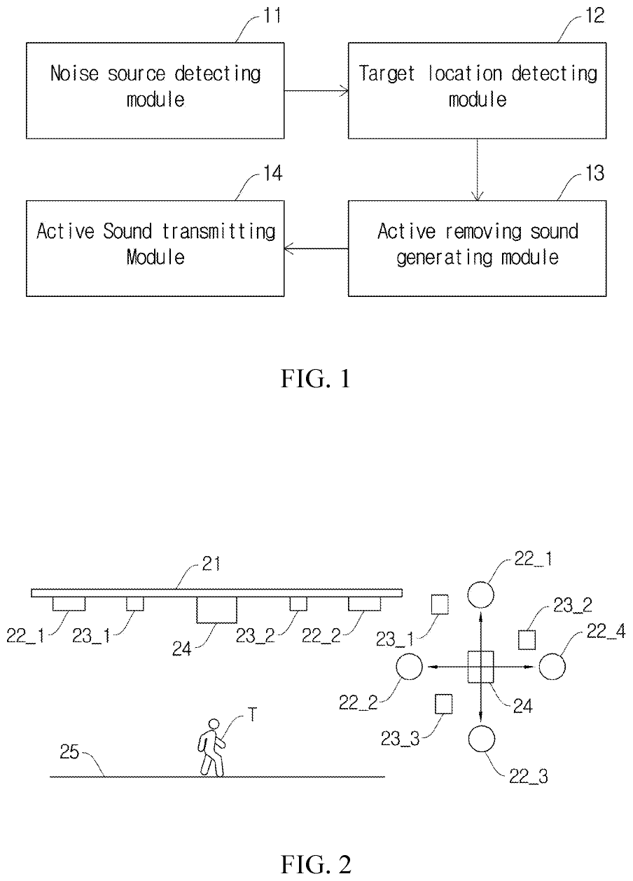

FIG. 1 shows an embodiment of a system for removing in an active way according to the present invention.

Referring to FIG. 1, a system for removing a noise in an active way comprises a noise generating source detecting module 11 for detecting a noise generating source generating a noise; a target location detecting module 12 for detecting a location of a target positioned at an area where the noise is transmitted; an active removing sound generating module 13 for generating an active removing sound capable of removing an effect of the noise transmitted to the target; and an active sound transmitting module 14 for transmitting the generated active sound to the target.

The system according to present invention is characterized in that: (A) installing a plurality of noise sensing vibration elements capable of sensing a noise from various directions at different places, (B) analyzing the noise signal amplitude by each noise sensing vibration element for determining a noise generating source, (C) tracing the targets to whom the noise is transmitted and determining a generating form and a direction of a virtual noise, (D) forming a virtual surrounding removal module with a matrix structure, (E) transmitting the removing sound with a reverse phase to the targets. The location of the targets may be detected by sensors such as an ultrasound sensor, a laser sensor or an infrared sensor, and a plurality of targets located at different positions may be detected, and if necessary, the locations of targets may be traced. The active noise removing system with such characteristics may be discussed in detail below.

The noise generating source may be detected by the noise generating source detecting module 11, and the detecting module 11 may comprise a plurality of noise detecting sensors installed at different places from each other, and the plurality of noise detecting sensors may be installed around a building, at a wall of the building, at a window or at an inner part of the building with each sensor separated.

The detecting module 11 may comprise various electric elements such as a vibrator, an amplifier, a filter or the like. The noise signals detected by the plurality of noise detecting sensors may be converted into transmittable electrical signals.

The detecting module 11 may detect the noise in real time, and analyze a direction of the noise, an amplitude of the noise, a wave form of the noise, a varying form over time of the noise or a generating period of the noise. Selectively, the detecting module 11 may comprise a tracing module, and the tracing module may analyze each detecting information of each sensor and judge a position of a noise generating source, a form of the noise generating source, a mobility of the noise generating source or a durability of the noise. And the tracing module may determine whether or not to trace the noise generating source depending on the result of the judgement.

While the noise generation information is traced by the tracing module, a state of a noise transmission space may be detected. A target or targets positioned at the noise transmission space may be detected by the target location detecting module 12, and the target or targets may become a person or persons.

The target location detecting module 12 may comprise a plurality of location detecting sensors installed within the noise transmission space, and the plurality of location detecting sensor may comprise an ultrasound sensor, a laser sensor or an optical sensor. Selectively, the target location detecting module 12 may comprise a location tracing module, and a location of the target may be traced by the location tracing module.

After the noise generating source is detected by the noise and the target location is detected by the target location detecting module 12, the active removing sound may be generated by the active removing sound generating module 13.

The active removing sound generating module 13 may generate a sound for removing each noise based on the detected information, and for example, the active removing sound generating module 13 may generate a sound capable of removing by interfering with the generated noise and having a reverse phase and an identical or a similar amplitude. And also, the active removing sound generating module 13 may generate a white noise to remove the effect of the noise.

The active removing sound may comprise various sounds to remove the generated noise or the effect of the generated noise. If the active removing sound is generated in this manner, then the active removing sound may be transmitted to the target by the active sound transmitting module 14. The active sound transmitting module 14 may amplify the generated removing sound or regulate the phase of the removing sound for transmitting to the target. An outputting means such as a plurality of speaker may be placed, and the removing sound may be transmitted to the target by at least one outputting means. The removing sound may be transmitted to the target in various ways, but not limited to.

FIG. 2 show an embodiment of a structure for detecting a noise generating source and a target according to the present invention.

Referring to FIG. 2, the noise generating source detecting module 11 may comprise at least three noise detecting sensors 22_1 to 22_4 placed at different locations from each other. For example, four noise detecting sensors 22_1 to 22_4 may be arranged on a ceiling of a building in a rectangular shape, and an active removing sound generating apparatus 24 may be placed at the center of the four noise detecting sensors 22_1 to 22_4.

And also, at least two location detecting sensor 23_1 to 23_3 may be arranged on the ceiling or a wall, for example, three location detecting sensors 23_1 to 23_3 may be placed in a triangular shape. A person corresponding to a target T may be on bottom surface 25.

A noise transmitted into a building may be detected by four noise detecting sensors 22_1 to 22_4, and a noise generating source of the noise may be detected by analyzing the amplitude of the noise or the direction of the noise. If the noise generating source is detected, then a space distributing form of the noise may be calculated. And a form of the active removing sound or a transmitting form may be determined based on the calculated result.

The active removing sound may be transmitted based on the location of the target T, the target T may become at least one, and the location of the target T may be variable. And the transmitting area of the active removing sound may be determined depending on the distribution of the target T or the location variation of the target T.

A generating source location map may be created based on the noise information detected by the noise detecting sensors 22_1 to 22_4 and a target distributing map may be created based on the target location information detected by the location detecting sensors 23_1 to 23_4. At least one active removing sound generating apparatus 24 may be installed in the noise transmission space, and the active removing sound generating apparatus 24 may communicate with the noise detecting sensors 22_1 to 22_4 and the location detecting sensors 23_1 to 23_3.

And also, the active removing sound generating apparatus 24 may comprise a direction controlling means for controlling the transmitted direction and an amplifying means for amplifying the volume of the transmitted sound. The noise transmitted to the noise transmission space such as a building may be eliminated effectively by the active removing sound generated by the active removing sound generating apparatus 24.

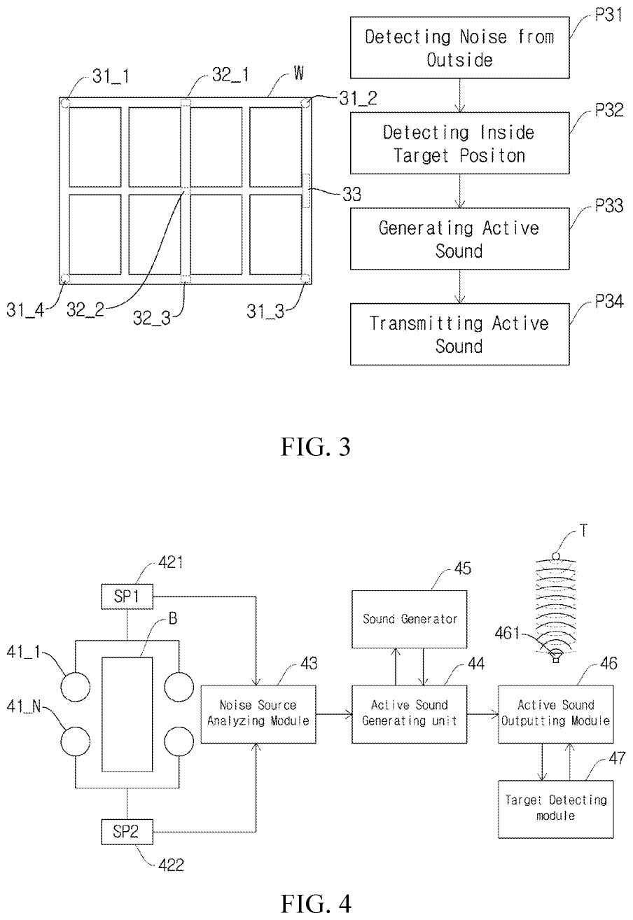

FIG. 3 shows an embodiment of a process for removing a noise transmitted through a window from the outside according to the present invention.

Referring to FIG. 3, the noise generating source detecting module 11 may be arranged on the ceiling or at the window W. Various kinds of noises are transmitted into the building through the window W, and the noises transmitted from various directions may be detected by four noise detecting sensors 31_1 to 31_4 arranged at a window frame.

The noise detecting sensor 31_1 to 31_4 may become a microphone or a vibrating sensor, and four noise detecting sensor 31_1 to 31_4 may be installed at the window frame in a rectangular shape for detecting the noise transmitted through the window W.

A plurality of location detecting sensors 32_1 to 32_3 may be arranged at the window frame or other various positions, and the active sound generating apparatus 33 may be installed at various positions. In such structure, the process for removing the outside noise transmitted through the window by the active sound is as follows: detecting the outside noise transmitted through the window by the noise detecting sensors 31_1 to 31_4 P31; detecting the location and the distribution of the target within the building by the location detecting sensor 32_1 to 32_3 P32; generating the active sound by the active sound generating apparatus 33 P33; and transmitting the active sound to the target P34. The noise transmitted through the window W may be removed in various ways, but not limited to.

FIG. 4 shows an embodiment a structure for removing a noise generated at an outside of a building according to the present invention.

Referring to FIG. 4, a plurality of noise detecting sensor 41_1 to 41_N may be arranged around a building B or in the building B, and a noise signal detected by each noise detecting sensor 41_1 to 41_N may be transmitted to at least one signal processor 421, 422.

Each detecting sensor 41_1 to 41_N may transmit the detected information such as a received direction of the signal, a frequency of the signal, an amplitude of the signal, a received time of the signal, a period of the signal or the like to the signal processor 421, 422 connected wired or wirelessly. The signal processor 421, 422 may convert the noise information from each detecting sensor 41_1 to 41_N into a transmittable electric signal, and thereby a noise data may be created.

The noise data created by each signal processor 421, 422 may be transmitted to a noise source analyzing unit 43, and the noise source analyzing unit 43 may analyze a noise generating state such as a noise generating source, a possibility of transmitting to the target, a removing way or the like. And the analyzed result by the noise source analyzing unit 43 may be transmitted to an active sound generating unit 44. The active sound generating unit 44 may determine the noise to be removed and may generate a removing sound using a sound generator 45.

And the active removing sound generated by the active sound generating unit 44 may be transmitted to an active sound outputting unit 46. The active sound outputting unit 46 may comprise a plurality of outputting means such as speakers arranged at different places from each other, and each outputting means may have a structure capable of regulating the transmitting direction.

A condition of the target such as a location of the target, a distribution of the target or a mobility of the target may be detected by a target detecting unit 47, and the target information may be transmitted to the active sound outputting unit 46. The active sound outputting unit 46 may determine the outputting means for transmitting the active sound, and may regulate the direction of the outputting means.

And then, the active sound may be transmitted through a speaker 461 along a predetermined direction to reach the target T for removing the noise. For example, the active sound with a phase opposite to that of the noise or a white noise may be transmitted to the target T through the speaker 461 for removing the noise transmitted to the building, but not limited to.

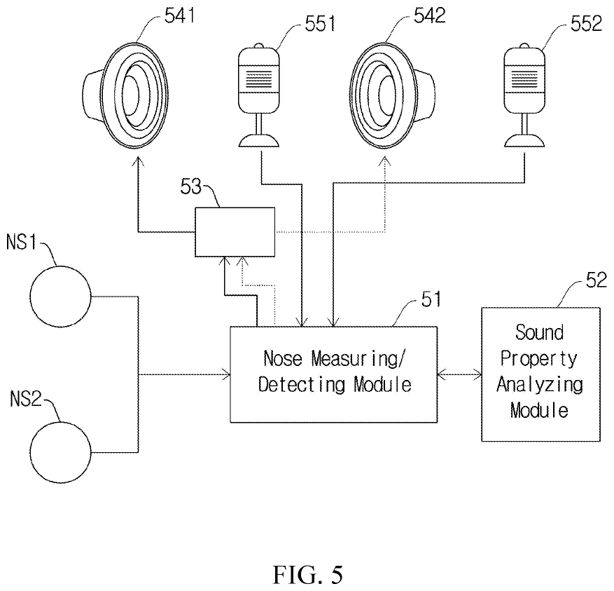

FIG. 5 shows an embodiment of a structure for removing a noise generated at a road or a street according to the present invention.

Referring to FIG. 5, a noise removing system may be installed at a road or a street generating a noise, and the noise removing system may be installed in various forms. A noise generated by a noise generating source NS1, NS2 such as a vehicle or the like may be detected by a detecting means 551 such as a microphone, and the detected noise may be transmitted to a measuring/detecting module 51 for detecting and measuring.

If a noise level is out of a predetermined range, then the noise property such as the kind of the noise, a generated form of the noise, a period of the noise, a mobility of the noise or a possibility of removal of the noise may be analyzed by a noise property analyzing module 52.

If the noise is to be removed based on the analyzed result of the noise property analyzing module 52, then a removing sound information to be generated may be transmitted to a generation selecting module 53.

The removing sound generated by the generation selecting module 53 may be transmitted to the noise transmission space through speakers 541, 542 forming a surround outputting module and arranged at different positions. An object detecting means 552 such as a microphone may be placed at the noise transmission space for detecting an outputting result of the removing sound of the surround outputting module.

Selectively, a target detecting means such as an ultrasound sensor, a laser sensor, an infrared sensor or the like may be arranged at the road or the street for detecting the target, and it may be detected by the target detecting means whether a person is or not. And the location of the person may be detected by the target detecting means.

The generation selecting module 53 may generate a removing sound with a phase opposite to that of the noise generated from the noise generating source NS1, NS1 or a white noise for alleviating the effect of the generated noise to be transmitted into the noise transmission space through the speaker 541, 542. And a transferred sound corresponding to a composite sound of the noise and the removing sound may be detected by a transfer detecting means 552 such as a microphone to be transmitted to the noise measuring/detecting module 51.

The noise measuring/detecting module 51 may analyze an information transmitted from the transfer detecting means 552 to transmit a removing result to the noise property analyzing module 52, and the removing sound may be corrected according to the analyzing result. The noise and the transferred sound may be detected by various kinds of detecting means, but not limited to.

The noise removing system according to the present invention can measure and analyze the noise transmitted state in a matrix way using the plurality of detecting elements based on the active noise cancellation skill, and thereby it is possible for a noise generating source to be detected accurately. The system according to the present invention may detect the location of the target that the noise reaches by a detecting means such as an ultrasound sensor, a laser sensor or the like, and may generate a virtual sound with a phase opposite to that of the noise to transmit the virtual sound to the target for removing the noise. The system according to the present invention enable the various kinds of noises generated at a road or a street to be removed, and if necessary, trace the target for removing the noise effectively. And thereby, the environmental noise of the road or the street may be prevented from affecting a person.

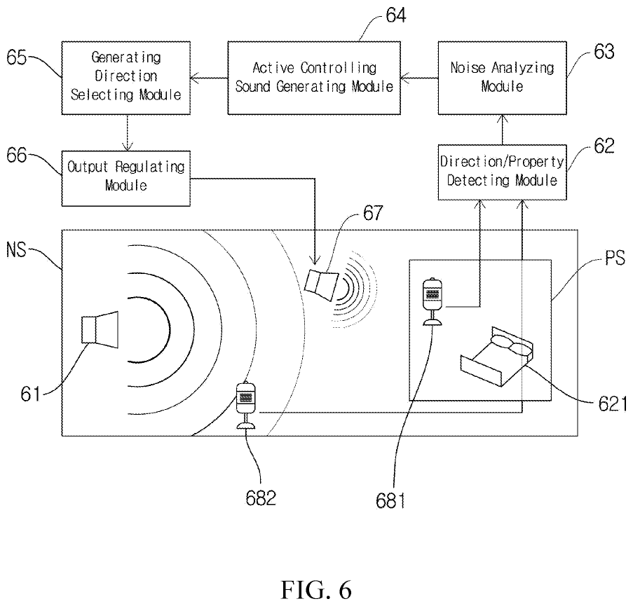

FIG. 6 show an embodiment of a structure for removing a noise generated between floors according to the present invention.

Referring to FIG. 6, the noise removing system may be installed at an inside part or outside part of a protecting space PS where a target 621 exposed to a noise is. The noise removing system may be installed within the protecting space PS or at an outside of the protecting space PS in an integrated form or in a plurality of separated modules capable of being connected to each other.

The noise removing system may be installed at the outside of the protecting space PS for removing the noise transmitted within the protecting space PS. The noise generated at the noise source 61 and transmitted to a noise space NS may be detected by a detecting means 682 such as a microphone.

The noise transmitted to the noise space NS may reach or not reach a target 621 located within the protecting space PS. It may be detected by an object detecting means 681 such as the microphone whether the noise reach target 621 or not and the detected result may be transmitted to a direction/form detecting unit 62.

There may be a plurality of the target detecting means 681, and the noise or the vibration transmitted to the protecting space PS may reach the target 621, and the direction/form detecting unit 62 may detect the property of the vibration or the noise such as an amplitude, a frequency, a direction or the like to reach the target 621 to transmit its results to a noise analyzing unit 63. The noise analyzing unit 63 may analyze the form of the noise or the vibration to determine whether an active removing sound has to be generated or not, and determine the generating conditions of the active sound such as the amplitude, the direction, or the duration time.

And the generating conditions of the active sound may be transmitted to an active sound generating unit 64, and an active sound may be generated by the active sound generating unit 64 according to the generating conditions. And the generated active sound may be transmitted to a direction selecting unit 65, and the active sound may be transmitted to an outputting regulating unit 66 to be amplified. And then, the active sound may be output through an outputting means 67 such as a speaker.

The removing sound with a phase opposite to that of the generated noise or a white noise for alleviating the effect of the noise may be transmitted to the protecting space PS through the outputting means 67 such as the speaker.

A transferred sound in which the noise is combined with the active sound may be detected by a transfer detecting means 681 such as the microphone to be transmitted to a noise analyzing unit 63. The noise analyzing unit 63 may analyze the information transmitted from the transfer detecting means 681 to correct the phase, the amplitude or the direction of the active removing sound. The noise or the vibration may be detected by various kinds of detecting means, but not limited to.

While the present invention has been particularly shown and described with reference to exemplary embodiments thereof, it will be understood by those skilled in the art that various changes in form and details may be made therein without departing from the spirit and scope of the present invention as defined by the appended claims.

What is claimed is:

1. A system for removing a noise in an active way comprising:
a noise generating source detecting module for detecting a noise generating source generating a noise;
a target location detecting module for detecting a location of a target positioned at an area where the noise is transmitted;
an active removing sound generating module for generating an active removing sound capable of removing an effect of the noise transmitted to the target; and
an active sound transmitting module for transmitting the generated active sound to the target.

2. The system according to claim 1, wherein the noise generating source detecting module comprises at least three noise detecting sensors placed at different positions each other.

3. The system according to claim 1, wherein the target location detecting module comprises at least two location detecting sensors.

4. The system according to claim 1, wherein the noise generating source detecting module is placed at a ceiling or a window.

5. The system according to claim 1, wherein the target location detecting module comprises an ultrasound sensor or an optical sensor, and is configured to have a function for tracing the location of the target.

6. The system according to claim 1, wherein the system further comprises a noise property analyzing module for analyzing a noise form, a noise direction, a periodic property or a generating characteristic.

7. The system according to claim 1, wherein the active removing sound is a white noise.
